(19) United States
(12) Patent Application Publication
(10) Pub. No.: US 2020/0333866 A1
(43) Pub. Date: Oct. 22, 2020

(54) END USER CONTROLLED LOAD MANAGEMENT SYSTEM

(71) Applicant: Christopher DUNBAR, Houston, TX (US)

(72) Inventor: Christopher DUNBAR, Houston, TX (US)

(21) Appl. No.: 16/764,025

(22) PCT Filed: Nov. 17, 2018
(86) PCT No.: PCT/US18/61707

§ 371 Date: May 14, 2020

Related U.S. Application Data
(60) Provisional application No. 62/588,343, filed on Nov. 18, 2017.

(51) Int. Cl. G06F 1/3203; G06Q 50/06; G05F 1/66; G05B 19/042

(52) U.S. Cl. CPC G06F 1/3203; G06Q 50/06; G05B 2219/2614; G05B 19/0426; G05B 2219/2639; G05F 1/66

(57) ABSTRACT

A control system is disclosed that controls both regular and smart high power usage devices based on real time pricing information. An end user through a user interface sets a trigger price above which the device will shut down or reduce power usage. The control system will operate independently of any system operator or utility and is controlled solely by the end user. A method is disclosed to elicit an end user's preferred trigger price (the price above which to reduce power to the high power usage device). The control system allows end users to override their pre-defined trigger prices to deliver preferable outcomes in response to external and environmental factors. In addition, a method to protect pool equipment from winter freeze events while responding to real time price signals is also disclosed, along with a temperature override device.

### RELATED APPLICATIONS

This application claims the benefit of U.S. Provisional Application No. 62/588,343, Nov. 18, 2017.

### BACKGROUND

### 1. Field of Invention

The present application relates generally to systems designed to monitor and regulate the use of electricity in both residential and commercial settings, as well as pricing in retail and wholesale electricity markets.

### 2. Background

Previous solutions for systems designed to monitor and regulate the use of electricity come in many forms that vary in their complexity, but all still have significant limitations.

One of the most basic solutions are time of use programs, where utilities and retail electric providers (REPs) charge end users different rates for using electricity during different times of the day with peak times costing far more than off peak times. The limitation with these programs is that they do not enable or incentivize a specific response at the times when demand and supply on the electric grid are out of balance.

Another solution that is well documented are demand response programs run by utilities and REPs. These programs offer an incentive to end users by rewarding them for reducing usage during a peak event. These programs often lead to confusion and disengaged end users. The reason for this, is the days prior to the event usually serve as a baseline, and the utility will look at the end user's usage during the event and compare it to the baseline period. The end user may have taken actions to reduce usage, such as adjust a thermostat, but the utility may determine that not enough of a response has been made, and the end user does not receive the incentive. As there is likely no mechanism for the end user to see their real time usage it is hard for the end user to know what the outcome will be at the time of the event. This leads to disengaged and frustrated end users. The clear limitation here is providing real time information to the end user and also the requirement to make manual adjustments to their high power usage devices.

More recently with technology advancements and the introduction of smart internet connected devices it has become possible to regulate power use automatically. Smart thermostat manufacturers have partnered with utilities and REPs to offer demand response programs where the utility or REP use the smart device to reduce usage. However, many end users don't like to give control of how they use power to a utility in this manner, and don't want someone else deciding how they use power. This has limited adoption of these programs so far. Furthermore, there are a number of different manufacturers of smart devices. As such, there is no guarantee that all smart devices will be compatible with all smart device demand response programs. In summary, significant shortcoming still remain with systems to regulate the use of electricity.

### SUMMARY OF THE INVENTION

The present invention takes a novel approach to regulating high power usage devices including but not limited to air conditioning and heating devices, pool pumps, water heaters, and electric vehicles. As part of the solution it is necessary to change the way the end user buys electricity. The majority of end users currently buy electricity on a fixed price basis. This means they sign a contract for a given period, usually no more than three years and they lock in the price they pay for each unit of electricity used during the contract period. This is usually expressed in cents per kilowatt hour (cents/kWh). The utility or REP who sold the contract to the end user will then buy a forward contract in the wholesale market at a fixed price to cover the expected electricity usage of the end user. This is referred to as a ‘hedge’ transaction. This will protect the utility or REP from being exposed to increases in wholesale power prices which can be volatile. Unless the precise amount of power which will be used by an end user is hedged the utility or REP will be exposed to changes in the underlying wholesale price of electricity. For the avoidance of doubt, if the utility sells electricity to the end user and prices increase, its cost to serve said end user will increase, while the price it sold electricity to the end user is fixed, so the revenue from the end user is fixed, and the margin the utility or REP expects to make will decrease or even become negative meaning they are losing money. Even with said ‘hedge’ transaction in place it is hard to buy the exact amount of electricity the end user will use, as usage is heavily related to weather and other factors that will not be known in advanced. As such the margin is not certain and will vary with the hedging policy of the utility or REP, the actual usage of the end user, and other market forces. If the utility or REP does not buy enough electricity for a given settlement period, as part of the ‘hedge’ transaction or subsequent transactions, the Independent System Operator (ISO) or control authority will force the utility or REP to buy additional electricity at the real time electricity price, through the settlement process. A settlement period is usually a time period between five and fifteen minutes, but will depend on the rules of the ISO or control authority. This then leads to the question ‘why do utilities and REPs not just charge end users the real time price?’ If they did so then if prices increase the utility or REP can just pass those costs on to the end user. This will mean they no longer need to enter into hedge transactions and they will have certainty on the margin they receive from the end user. Historically there have been two strong arguments against selling real time price contracts.

The first relates to the volatility of real time prices. The real time price of electricity represents the cost of electricity in the current time period and will usually change in sync with the settlement period typically every five to fifteen minutes. To demonstrate the extent of volatility in real time electricity prices: in the ERCOT (Electricity Reliability Council Of Texas) market, the price cap is $9/kWh. ERCOT reports that the average price for 2017 was 2.8 cents/kWh. The price cap is the highest price the real time market can reach and it is defined by regulation. This therefore means prices can increase from 2.8 cents to $9 within a five minute period. As end users are limited in their ability to control their usage (as outlined in the background section), if they were exposed to high prices for long periods of time, then their final monthly bill could be substantially higher than their normal bill. As a result, utilities and REPs have not offered real time electric contracts to end users, and instead continue to sell fixed price contracts. Fixed price electricity contracts essentially provide an insurance product against high real time energy prices.

The second reason for selling fixed price contracts over real time price contracts is that it is much simpler computationally to create a bill. All that is required for a fixed price contract is the contract price and the total metered usage for each end user. The usage multiplied by the price gives the total electricity cost. However, to bill an end user with a real time price contract, it is necessary to calculate the energy cost for each 5 to 15 minute period, by multiplying the real time price by the five to fifteen minute usage data provided by a smart meter. This means that a 30 day, 720 hour month would need 2880 calculations based on a 15 minute settlement period. This demonstrates the additional complexity required to calculate a real time electric bill.

Over recent years computing power has increased exponentially. The invention of cloud computing, and on-demand processing, allows many processes be run in parallel without the need to maintain expensive servers that may sit idle the majority of the time. This ability to distribute calculations has greatly reduced the cost and reduced the time required to make real time billing calculations. With advances in technology this is really no longer a constraint.

The only obstacle therefore to offering real time pricing contracts to end users is the potential exposure to high prices. This is the exact problem the present invention will solve. The invention assumes the end user has transitioned to paying a real time electricity price. Electricity prices spike relatively infrequently. However, when they do so they are substantially higher for the short spike period. For a very low interruption rate, an end user is able to make substantial savings. As an example, historical price data between 2011 and 2017 in the ERCOT market shows that for a 1% interruption rate, end users would yield energy cost savings in excess of 20%.

In addition to the direct cost savings made by the end user, the invention brings additional social and societal benefits. If real time prices are high, this means that the most inefficient and polluting power plants will be running to meet demand. The invention therefore discourages usage when power generation is most polluting, so it also brings environmental benefits. When real time prices are extreme, then demand and supply are out of balance, and the risk of blackouts and electric grid collapse are elevated. By helping to reduce usage at these times the invention therefore also helps to keep the electrical grid stable for all.

The invention is a hardware and software combination that:
a) elicits an end user's preferred price above which high power usage devices shutdown or reduce power intake. This is referred to as the trigger price which is elicited through a user interface. For those who understand electricity markets, setting the trigger price directly is a relatively trivial task. However for an end user who is very unlikely to have such knowledge a method is described, that allows the end user to set a trigger price indirectly, without even displaying said trigger price to the end user. The method involves calculating and displaying the trade off between how much the end user can expect to have electricity supply interrupted to the high power usage device (when price spikes occur), and how much they can expect to save by doing so. The method makes it very easy to change the settings for the expected interruption and expected savings, allowing the end user to quickly setup or change their preferences.
b) once the trigger price is chosen the control system hardware receives the real time electricity price. This price may be taken from the ISO or control authority website or a direct feed from ISO or control authority servers. Once received the system will interrupt power flow to the device if the real time price is greater than the trigger price, and allow power to flow if the real time price is less than the trigger price. An override switch is also included that has an on and off option. When the override switch is set to on, even if the real time price is higher than the trigger price, power will remain flowing to the device. This gives the end user flexibility to keep the power on if they happen to value the power more at that instance. For example if the end user is having a party at their house they may decide they do not want the air conditioning being interrupted. If the high power usage device is a smart device, then a software control message is sent to said high power usage device to reduce or cut usage instead of using a hardware switch to achieve the same effect.
c) In the preferred embodiment the control hardware is also connected to current sensors to measure the overall electricity usage as well as the electricity usage by appliance. This gives the end user real time usage information through the user interface. This will give the end user peace of mind that when prices are high they can see that their usage has actually been reduced. Having appliance level usage data also informs the end user of how much each device is using and how much it is costing them to run. As a result the end user will also be able to make adjustments to devices that are wasting power by running excessively. For example an air conditioner may be running hard in an area of a building that is not frequented so the device can be switched off. The usage data collected by the control hardware will allow the end user to make such inferences and change their behaviour. So as well as reducing usage when prices are high, the device will also help the end user reduce their overall power usage.
d) For temperature sensitive devices that use a thermostat to control when they run, a thermostat override device is introduced. This device will connect near an air conditioning or heating system's thermostat, and send temperature and humidity information to the control device. This then allows constraints of temperature to be built into the decision to run or not run the air conditioning or heating system. Temperature triggers can be used in the same way as trigger prices, so that if the temperature increases above or reduces below the temperature trigger the air conditioning or heating system will switch back on even if prices are still above the trigger price to maintain a comfortable temperature.

The system requires no utility, REP, ISO or control authority input, and the end users will make decisions to cut power to their devices to save themselves money. This is one of the key advantages of this system. At no point can a utility, REP, ISO or control authority make any changes to the end user's usage. In other words, the end user remains in full control all the time and as such the present solution is much more palatable to the end user than imposed controls by a utility, REP, ISO or control authority. The end user still has complete flexibility in how they consume electricity. If the end user wants to use power when it is expensive, they can choose to do so.

### BRIEF DESCRIPTION OF DRAWINGS

FIG. 1 shows an exemplary implementation of the user interface used to elicit an end user's preferred trigger price above which to reduce or cut power to a high power usage device.

FIG. 2 illustrates an alternative implementation of the user interface used to elicit an end user's preferred trigger price above which to reduce or cut power to a high power usage device.

FIG. 3 illustrates an exemplary implementation of the control and measuring hardware.

FIG. 4 shows an exemplary user interface to display usage and price information to an end user.

FIG. 5 illustrates an alternative implementation of the control and measuring hardware.

FIG. 6 illustrates a single pole combined switch and current sensing device.

FIG. 7 illustrates a dual pole combined switch and current sensing device.

FIG. 8 illustrates how a temperature override device interacts with the system.

FIG. 9 shows the user interface to setup the temperature override device.

FIG. 10 illustrates an embodiment of the temperature override device into an energy monitor

FIG. 11 illustrates an alternative embodiment of the temperature override device that connects to a wall electrical socket.

FIG. 12 shows the user interface to setup freeze protection for pool equipment.

FIG. 13 illustrates how the system controls and interacts with smart devices.

FIG. 14 illustrates an overall view of the invention comprising all of the main components and their interactions.

FIG. 15 shows the user interface of the system override functionality.

### DETAILED DESCRIPTION OF THE INVENTION

The present invention is a combination of hardware and software components that interact together allowing an end user to make choices to shut down or reduce power to their high power usage devices. Devices include but are not limited to air conditioning or heating systems, water heaters, pool pumps, electric vehicles or any other high power usage device. The system as described works with both regular devices (devices that are not network or internet connected and controllable through software) and smart devices (devices that are network or internet connected and are controllable through software). The system will operate without the direct involvement of an ISO, REP, or Control Authority. Instead, the end user is enabled through the present invention to make the decision to cut their electricity usage to save money for themselves directly by avoiding usage during high price times.

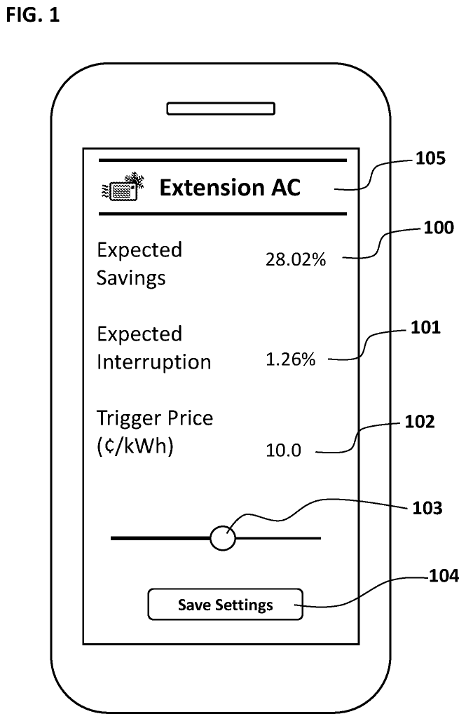

The first step in implementing the invention is eliciting the end user's preference for a trigger price. FIG. 1 depicts the exemplary user interface used to input the necessary preference. The principle of the invention is to shut down high power usage device when real time prices are high. The end user will determine what is considered a high price by setting a trigger price. The trigger price is a price above which electricity usage is reduced or cut to the high power usage device. Each high power usage device will have a differing amount of flexibility and impact on the end user when it's power usage is reduced or cut. For example, a water heater especially in a warm climate can be without power for a long period because the hot water is stored in an insulated tank meaning the water will still come out warm after many hours. Compare this to an air conditioning unit. If an air conditioning unit is left off for hours at a time then the building will warm quickly, causing discomfort to the end user. As a result because the value of keeping an air conditioning unit on is higher than a water heater it is likely the user will want to set a higher trigger price for the air conditioning unit. Unfortunately, although setting a trigger price directly is easy for someone familiar with electricity markets, an end user is unlikely to have the necessary background to set the trigger price directly. For the end user, two more comprehendible concepts are, how often is it expected that will power be interrupted to the device (expected interruption), and how much money is expected to be saved by doing so (expected savings). One method to calculate an expected savings and expected interruption would be to look at historical real time pricing data. For example you could take 5 years of 15 minute real time prices and work out how much of the time the real time price was above the trigger price. For example 5 years, is 43800 hours. If there were 500 hours during a 5 year period when the real time price was greater than the trigger price, this would mean historically at least interruption would occur 500 hours out of 43800 hours which is 1.14% of all hours. In the preferred embodiment this expected interruption rate is shown as a percentage 101 on the user interface illustration. In another embodiment 101 may be represented in different units, for example you could have minutes per day which in this example would be, 1440 minutes in a day, so 1.14% multiplied by 1440=16 minutes per day. Another alternative would be hours per month, assuming a 30 day month (720 hours), so 1.14% multiplied by 720 hours=10 hours per month. All embodiments are equivalent and just make use of different units to represent the same result.

To calculate the expected savings is a little more complex. Firstly an assumed running profile of the high power usage device needs to be agreed, where the running profile is how much power is consumed by the high power usage device for each 5 to 15 minute period of the day. The most robust solution to this problem would be to use historical usage data of the device being interrupted. If this is available it should be used in a preferred embodiment, however it is unlikely that this would be available. Another estimation process is therefore required. A reasonable estimation will likely vary by device. As an example if the device has a constant load, such as a pool pump that runs every hour of the day, it might be modelled as using 1 kW of power each hour. Another alternative for estimating device usage might be to use settled smart meter 15 minute data from the end users smart meter. Using the chosen methodology for establishing the running pattern of the device uninterrupted, for each 15 minute period the usage data is multiplied by the associated historical real time price, which is then summed to give the total baseline cost. An alternative baseline cost might be an assumed fixed price the end user would have to pay for power under a traditional fixed price electricity supply contract. As discussed previously the majority of end users currently pay an agreed fixed price for every unit of power they use during a contract term which may be anywhere from 3 months to 3 years or longer. If a fixed price of 10 cents/kWh is used then the baseline cost is simply the 10 cent/kWh multiplied by the total modelled usage. The next step is to calculate the cost of running the device while interruption occurs. To do this, for the periods when the real time price is great than the trigger price, the usage either goes to zero if the supply is cut completely or is reduced significantly (for example a smart device will reduce its usage significantly rather than completely shut down). This is the adjusted usage profile. For each 15 minute period the adjusted usage profile is taken and multiply by the 15 minute real time price. This cost is then summed for all periods to calculate the adjusted cost. Using the historical data the expected savings are simply the baseline cost minus the adjusted cost. In the present invention 100 shows the expected savings calculated as a percentage. For example if the baseline cost was $1000 and the adjusted cost is $750, the savings are $250, expressed as a percentage the savings would be $250 divided by $1000 which is 25%. In an alternative embodiment the expected savings 100 would be expressed in an alternative unit, for example if the historical period of the above example was 1 year, the savings could be expressed as $250 per year, or $20.83 per month ($250 divide 12 months), or $0.68 per day ($250 divide 365 days). All these embodiments would be equivalent, and just make use of different units to display the same result.

In the exemplary embodiment 102 shows the trigger price also included with the expected savings 100 and expected interruption 101. By showing the expected interruption and expected savings the end user already has enough information to make a decision about where they want to set the trigger price, as they can chose a point they are comfortable with in terms of the trade off that exists between expected savings and expected interruption to the high power usage device. As a result, in an alternative embodiment the trigger price 102 may not even be shown on the user interface, however the associated trigger price would still be stored and used as a decision point as to whether power is curtailed to the high power usage device. This described method for calculating the expected savings and expected interruption is then run for a range of discrete trigger price levels, and the associated expected savings and expected interruptions are saved to a storage medium, such as a database, along with the trigger price.

It has been established that there is an associated expected savings 100 and expected interruption 101 associated with each trigger price 102. The end user therefore needs a way to compare the expected savings and expected interruption for each trigger price level. In the exemplary invention this is achieved through a slider 103. A slider is a standard user interface feature for all desktop and touch based user interfaces. As the slider 103 slides rightwards this will increase the trigger value 102, and at the same time the expected savings 100 and expected interruption 101 will also adjust to their new values based on the new increased trigger price. As the slider 103 moves leftwards this moves the trigger price 102 lower and again the values for expected savings 100 and expected interruption 101 are updated on the user interface at the same time to reflect the new lower trigger price. This user interface provides a quick and easy method for the end user to compare trigger levels, expected interruptions, and expected costs so they are able to choose their preferred settings. Once the end user is happy with their selection the trigger price is saved to the back end of the system by tapping the save button 104. The end user names each high power usage device connected to the system shown in 105 and will repeat this process for each high power usage device, potentially choosing different trigger prices for each depending on how much they value having the high power usage device run normally, and the effects of interrupting it. In an alternative embodiment the slider 103 is removed, and instead one or all of the expected savings 100, expected interruption 101, trigger price 102 would become editable text box. The end user would touch the value of each which would then allow them to change the value. When any of the three values are changed, the remaining two values would updated instantly to the associated values for the new value that was entered.

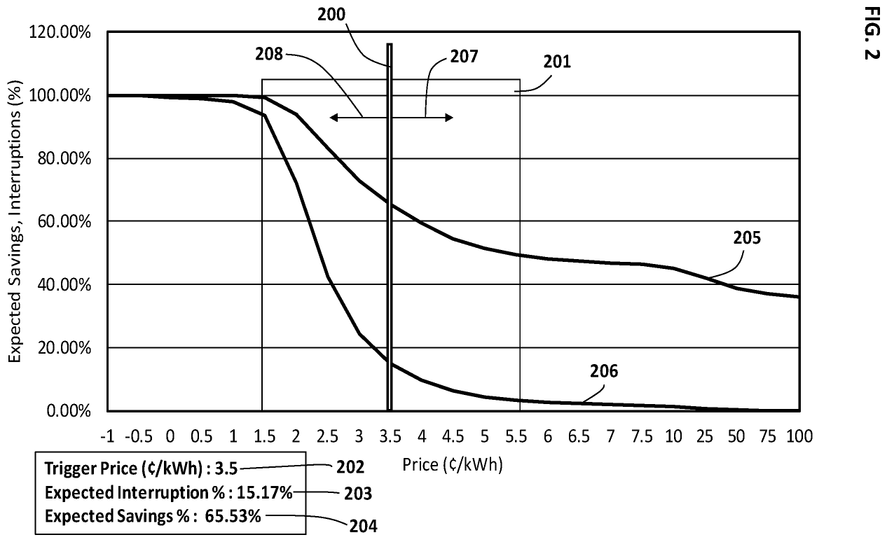

FIG. 2 shows an alternative embodiment of the user interface to elicit an end users preference for a trigger price. In this embodiment the slider is the black vertical line bar 200. The end user can move the slider horizontally to change the trigger price. The movement is represented by the arrows 207 and 208. As illustrated the trigger price is set at 3.5 cents/kWh, which can be read off the horizontal axis of the graph as well as below the graph shown in 202. The expected interruption 203 and expected savings 204 are also shown. Their values can be read off the graph too. The expected interruption against trigger price is shown by the line 206 and the expected savings are shown by line 205. The shaded area 201 is showing the area where prices can be expected to be 95% of the time. This is simply for informational purposes for the end user. As the sliding bar is moved by the end user as in the embodiment in FIG. 1, the trigger price 202, expected interruption 203, and the expected savings, 204 are updated on the user interface screen immediately in the same way in FIG. 2. As the trigger price, expected interruption, and expected savings can be read from the graph directly, in another embodiment 202, 203, and 204 could be removed, although it is likely that they will be preferred to be included for clarity. Although not shown in FIG. 2 to focus on the new features a save button would also be included similar to 104. The main advantage of the embodiment in FIG. 2 over FIG. 1 is that it shows the rationale of the system very clearly. Even at relatively low trigger prices, the expected savings increase relative to the expected interruptions very rapidly as shown by the divergence of the expected interruptions line 206 and the expected savings line 205. This makes it very clear to the end user that large savings can still be made for much smaller interruption rates.

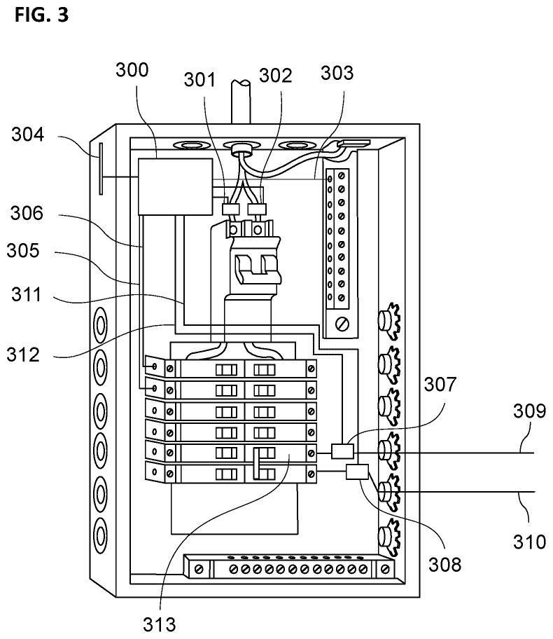

Now that it has been shown how a trigger price is chosen by the end user, the next step is to show how the hardware interacts with devices to create savings for the end user. Electricity arrives at the end user's location through utility lines that pass through a meter then into a breaker panel and out to individual devices and circuits. The breaker panel is therefore the ideal location to locate a device where the intention is to interrupt power flow to many devices at once. FIG. 3 provides a detailed illustration of how the hardware is physically connected into the breaker or fuse box and is able to interact with other devices to interrupt power flow to them as well as make measurement of power usage for real time feedback to the end user through the user interface. The hardware is controlled by the network connected microcontroller 300, which itself comprises a logic processor, memory, a network adapter, and general input and output pins for interacting with switches and sensors. In the present embodiment, the network connection is wirelessly through a wifi antenna 304. In alternative embodiments the network connection may use a wired solution such as ethernet, or powerline network technology such as powerline over ethernet. All network connection types serve the same purpose of connecting the network connected microcontroller to the internet and are equivalent. The network connected microcontroller is powered directly off a dual pole breaker via the hot wires 305 and 306. The circuit to the network connected microcontroller is completed by wire 303 running to the neutral bus bar. The network connected microcontroller 300 has a built in analogue to digital converter allowing it to take readings from sensors. The network connected microcontroller 300 is firstly connected to two current sensors 301 and 302. These sensors are standard hall effect current sensors allowing them to send current readings without interfering with the physical power flow. For ease of installation in the preferred embodiment they will be of split core type and will simply clip on to the main service lines. The network connected microcontroller 300 also has a built in voltage sensors, which when combined with the current readings from the current sensors 301 and 302 allows the network connected microcontroller 300 to calculate the total power usage at the end user's location. In addition, the network connected microcontroller 300 is also connected to a series of combined switch and current sensing devices 307 and 308, via the wires 311 and 312. For simplicity in the illustration of FIG. 3 only two combined switch and current sensing devices 307 and 308 are shown. There will be many switch and current sensing devices used if the end user desires to control many high power usage devices. The switch and current sensing devices are connected in line between a circuit breaker 313 and the hot supply lines 309 and 310 that supply power to the high power usage device that will be controlled. Operationally the system works as follows, the network connected microcontroller 300 receives a real time price through its network connection, it also receives the trigger price selected by the end user through the user interface. If the real time price is lower than the trigger price, then the network connected microcontroller 300 will send a low voltage direct current (DC) signal to the combined switch and current sensing devices 307 and 308 and the switch then allows high voltage alternating current (AC) power to flow to the high power usage device. If the real time price is greater than the trigger price, then no low voltage dc signal is sent by the network connected microcontroller 300 to the combined switch and current sensing device 307 and 308 resulting in no power flowing through the AC supply lines 309 and 310 and hence the high power usage device will be turned off. This process will happen on many devices at once with potentially differing trigger prices. At the same time the network connected microcontroller 300 takes continuous current readings and displays the calculated power readings to the user interface.

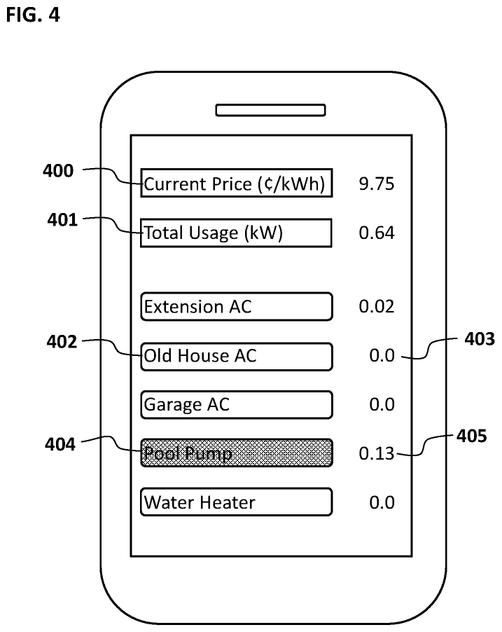

An example of said user interface presenting power usage information is shown in FIG. 4. The real time price is shown as 400 and labelled as “Current Price” with a value of 9.75 cents/kWh. The total usage of the location is shown in 401 labelled as “Total Usage” and shows a value of 0.64 kW. In the exemplary embodiment a total of five high power usage devices are listed, each has been given a name created by the end user. In 402 a device the end user has called “Old House AC” is shown which has a usage 403 of 0 kW. The only high power usage device that is running in the present embodiment example is the “Pool Pump” 404 which has a usage of 405 0.13 kW. The values of usage and current price update instantaneously as a new price is received and the network connected microcontroller takes a new usage reading. The system could be configured to take readings at any interval from updating every few milliseconds to minutes at a time. In the preferred embodiment it has been found an update every 20 to 30 seconds is acceptable by end users while also being sufficiently long enough that the costs associated with transmitting the data are not too extreme.

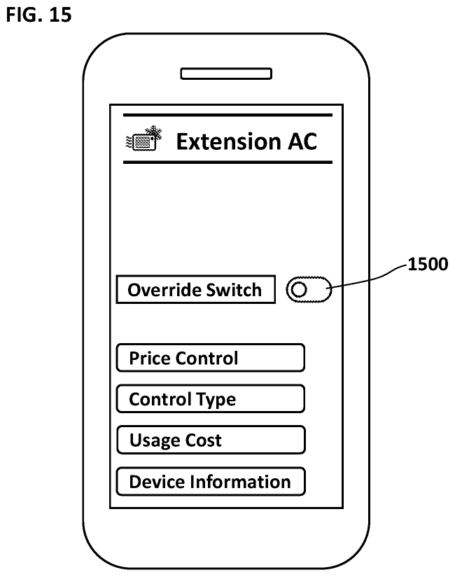

The value the end user places on having power flow to devices will vary with time, and circumstances. For example, if there is no one at the location, then the value of air conditioning is very low. However, if the end user has guests at the location then they will likely want to keep the temperature comfortable for their guests and the value they place on heating and cooling equipment will be higher than usual. The end user could simply change their trigger price settings to take this into account, however there may be situations such as having guest where the end user wants to have power irrespective of price. In this case the user interface provides an override switch 1500 as shown in FIG. 15. If the override switch is set to the on position, then the network connected microcontroller will allow power to flow to the high power usage device at all times irrespective of price. When the end user sets the switch to the off position, the trigger price will be re-enabled and the high power usage device will have power flow interrupted or reduced as before depending on the real time price and trigger price.

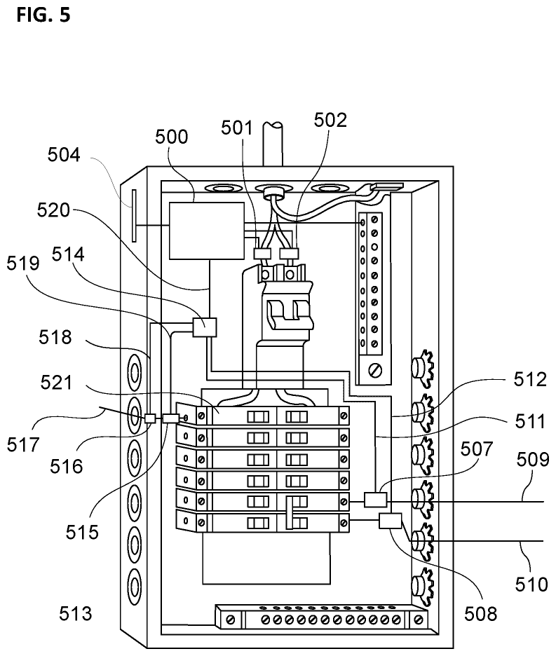

FIG. 5 illustrates an alternative embodiment of the hardware setup shown in FIG. 3. In this embodiment the combined switch and current sensing devices shown in 307 and 308 have the combined functionality split into two separate components. A breakout connector 514 is also introduced. Instead of connecting the high power usage switches and sensors directly to the network connected microcontroller 500 there is now only one connection per high power usage device to the network connected microcontroller, as the relay switch 515 and the current sensors 507, 508, 516 connect via the breakout connector 514 through a single ribbon cable connection 520 to the network connected microcontroller 500. As presented in FIG. 5 it is assumed the device is connected to an air conditioning unit. The air handler of the air conditioning unit is connected through a single pole breaker 521. The relay switch 515 is fitted in line with said single pole circuit breaker so as to be able to interrupt power to the air handler. In addition a current sensor 516 measures the power to the air handler, while 517 shows the supply line going to the air handler. 519 shows the switch connection back to the breakout connector, and 518 shows the connection from the current sensor 516 back to the breakout connector 514. The compressor of the air conditioning system is connected through a two pole circuit breaker 513. As interrupting power flow to the air handler will also interrupt power flow to the compressor there is no need to have switches on the compressor, but it is still necessary to measure the power usage of the compressor. This is done using current sensors 507 and 508, which are connected via the lines 511 and 512 to the breakout connector 514. 509 and 510 show the supply lines to the compressor. The current readings from current sensors 516, 507, 508 are summed together to give the overall power usage reading of the air conditioning system. The rest of the setup is similar to FIG. 3 with 504 showing the wifi antenna for the network connection, 501 and 502 are the current sensors monitoring overall power usage. It should be noted the cables that connect the network connected power controller to the circuit breaker 305 and 306 and neutral 303 have been removed from FIG. 5 to focus on the new features of the embodiment, but they are still present on this alternative embodiment as well.

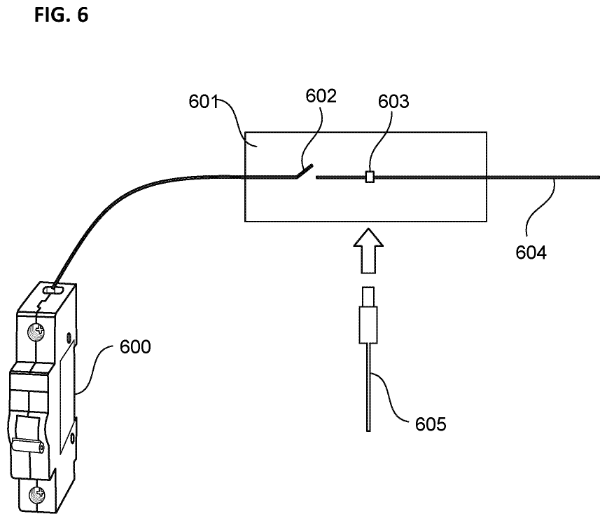

FIG. 6 illustrates the preferred combined switch and current sensing devices shown in 307 and 308 in more detail. In FIG. 6 the combined switch and current sensing device 601 is connected to a single pole circuit breaker 600, and sits between said circuit breaker and the supply line 604 running to the high power usage device. The switch is shown in 602. It should be noted that two competing technologies may be implemented for switching. Firstly an electro-mechanical relay switch may be used whereby a low voltage direct current signal is used to energize the switch by causing a metal plate to move into a position to connect and complete the alternating current circuit and hence allow power to flow to the high power usage device. Alternatively a solid state relay switch may be used whereby the low voltage direct current switch energizes a light emitting diode, the light from which energizes an optocoupler which then energizes a triac allowing the alternating current to flow to the high power usage device. The advantages of the solid state switch are that switching requires no mechanical process, which means solid state relay switches will generally last longer than mechanical switches before they fail. The other advantage of the solid state relay switch is a zero cross type can be used. This means that power flow will only start and stop at the zero point in the sinusoidal power waveform. This helps to protect high power usage devices from power surges at start up. The downside to solid state relays is they tend to have higher resistance and a larger voltage drop across their terminals. As such each could be used in an embodiment, but as they perform the same function they should be considered equivalent. 603 shows the current sensor used to measure power usage, and 605 shows the cable that provides the low voltage direct current power to energize the switch as well as connect the sensor back to the network connected microcontroller.

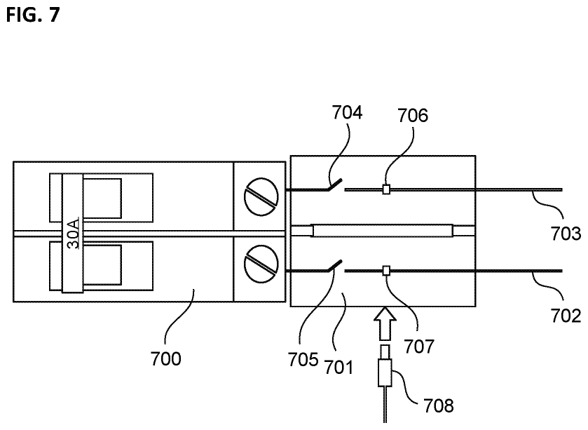

FIG. 7 shows a similar combined switch and current sensing device 701 for a dual pole breaker 700. The setup is almost identical to the single pole except there are now two switches 704 and 705 and two current sensors 706 and 707, one for each line of the 220V high power usage device, with 702 and 703 showing the supply lines to the high power usage device. The connector 708 connects back to the network connected microcontroller, sending current sensor readings and also energizing the switches. It should be noted to protect the high power usage device the switches 704 and 705 are setup to start simultaneously and stop simultaneously.

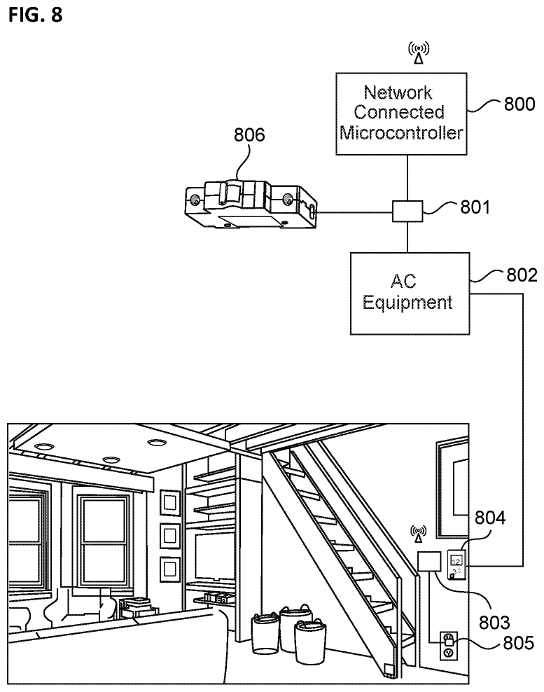

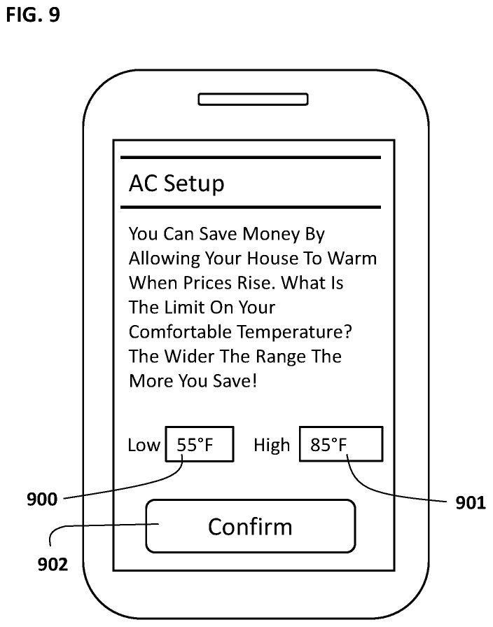

FIG. 8 shows an extension of the main system embodiment whereby a thermostat override system is used. It can be appreciated that if an air conditioning system is turned off for an extended period of time then the internal temperature will increase and could cause discomfort to the end user. The thermostat override device 803 is powered through an electric plug 805 and is wirelessly connected to the network connected microcontroller 800. As described in FIG. 3 and FIG. 5 the air conditioning system 802 can have power interrupted to it through a switch 801, that sits between the air conditioning system 802 and the circuit breaker 806. When power is interrupted the air conditioning system shuts down resulting in power loss to all components of the air conditioning system including the thermostat 804. The thermostat override device continuously sends temperature and humidity information to the network connected microcontroller. As shown in FIG. 9 the end user selects a minimum temperature 900 and maximum temperature 901 they are prepared to bear while real time prices are above the trigger price. The settings are saved by pressing the confirm button 902. If while the real time price is greater than the trigger price and the temperature reported by the thermostat override device is less than the minimum temperature 900 or greater than the maximum temperature 901, then the switch 801 will be energized to allow power to flow to the air conditioning system again. As the air conditioning system runs, the thermostat override device will report the lower temperature. As soon as the reported temperature is above the minimum temperature, or below the maximum temperature set by the end user on the user interface in FIG. 9 and if the real time price is still greater than the trigger price, then power flow to the air conditioning system will again be interrupted. It should be noted in FIG. 8 the thermostat override device 803 will ideally be located as close as possible to the thermostat 804 so the readings it takes will be a close as possible to the thermostat.

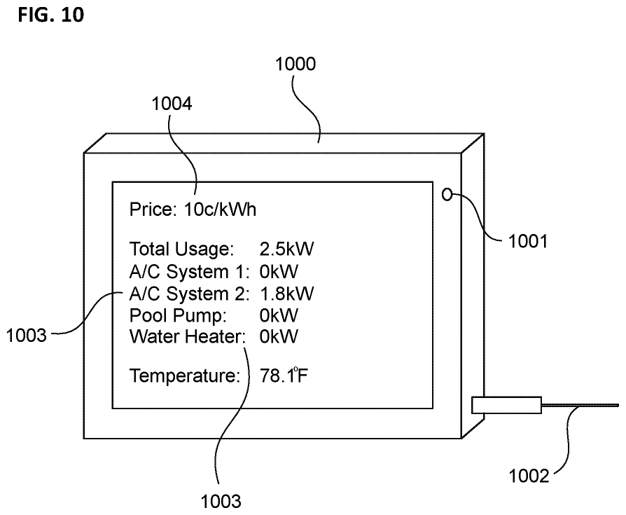

The thermostat override device may come in a variety of embodiments. FIG. 10 shows an embodiment where an energy monitor is integrated into the thermostat override features. The thermostat override device 1000, has a screen displaying the current real time price 1004, and usage information of each device and total usage 1003. The temperature reading is taken by a sensor 1001 and the current temperature reading is displayed on the screen 1003. The device is powered through the power cable 1002.

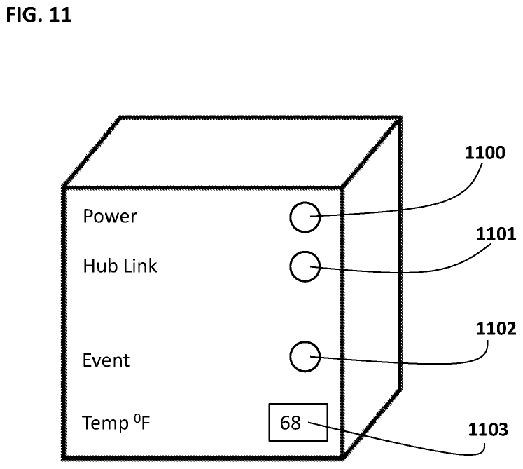

An alternative embodiment is shown in FIG. 11. Here there is no screen, instead a square block inserts directly to a wall socket. The square block may have no other external physical features, simply having a black front face. It will have an internal temperature sensor that will wirelessly send temperature readings back to the network connected microcontroller. Optionally as shown in FIG. 11 a number of light emitting diodes indicating the current state can be included. Firstly, a power light emitting diode indicator 1100 is shown that is green when the device has power. A hub link light emitting diode indicator 1101 is green when the thermostat override device has successfully connected to the network, and red when it is disconnected. An event light emitting diode indicator 1102, that is green when power is flowing to the air conditioning system, and red when power is interrupted. A temperature display 1103 that shows the current temperature reading. This will be green when the temperature is lower than the maximum temperature and higher than minimum temperature set by the end user in the user interface as shown in FIG. 9. If the current temperature reading is higher than the maximum temperature and lower than the minimum temperature set by the end user then the temperature display will be red.

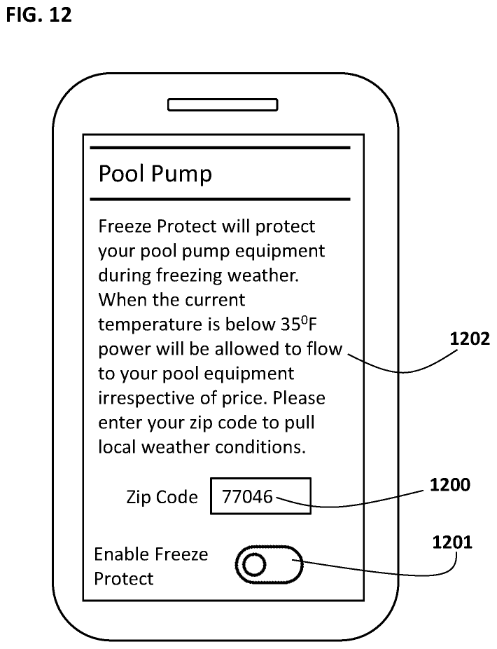

FIG. 12 illustrates another additional feature of the overall system, freeze protect. When freezing weather happens pipes become at risk of freezing. As water turns to ice it expands and can cause damage to pipework. This risk is much higher if the water in the pipework is not flowing. It is therefore recommended that pool pumps are run continuously during freezing events. With freeze protect the end user uses a user interface to enter their zip code 1200. The zip code is sent to the network connected microcontroller. The network connected microcontroller then uses an internet weather service likely through an application programming interface to continuously pull the latest temperature information for the zip code entered by the end user. When the enable freeze protect button 1201 is set to the on position, the system will always allow power to flow to the pool equipment when the temperature is below a set temperature near freezing point. In the present embodiment, the text of the user interface 1202 shows this is set at 35° F. in the present example.

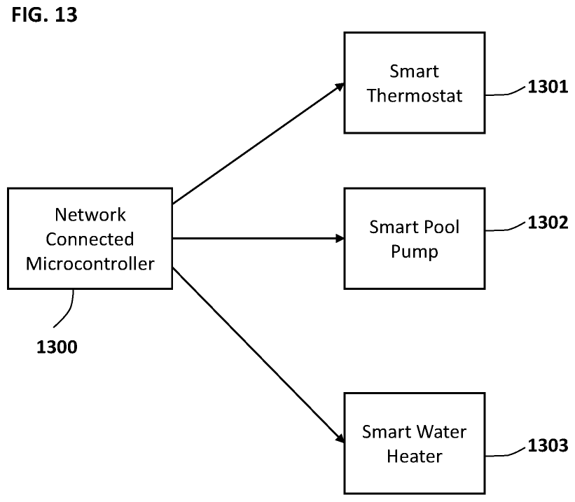

FIG. 13 shows an illustration of how the present invention can control smart devices. In FIG. 3 and FIG. 5 a detailed illustration is shown how switches can be placed in line with the supply lines of regular devices to cut power supply to a high power usage device. With a smart device a hardware switch is not required. Instead the network connected microcontroller 1300 sends a software control message to the smart device. In the case of a smart thermostat 1301, if the real time price is greater than the trigger price, then the command may be to increase the maximum temperature and minimum temperature as a software version of the thermostat override device as illustrated in FIG. 9. The current thermostat schedule is replaced by the high and low values shown in 900 and 901 and these values are entered in the same way by the end user through the user interface. Alternatively the software message sent by the network connected microcontroller may be a simpler command to turn off while the real time price is greater than the trigger price, and another message is sent to turn back on when the real time price is less than the trigger price. For a smart pool pump 1302 the software message sent might be to reduce the speed that the pump is running at when the real time price is higher than the trigger price. When the real time price is below the trigger price the speed will increase back to its regular setting. As with the smart thermostat, the control may also be a simple on and off type, whereby the smart pool pump shuts down the motor completely when the real time price is greater than the trigger price, and returns to normal operations when the real time price is less than the trigger price. For a smart water heater 1303, when the real time price is greater than the trigger price, the temperature setting on the thermostat could be set to a lower level so the water heater heating element will be energized less. Equally the simple on and off mechanism could be implemented, whereby heating element of the water heater is shut down when the real time price is greater than the trigger price, and re-enabled when the real time price is less than the trigger price.

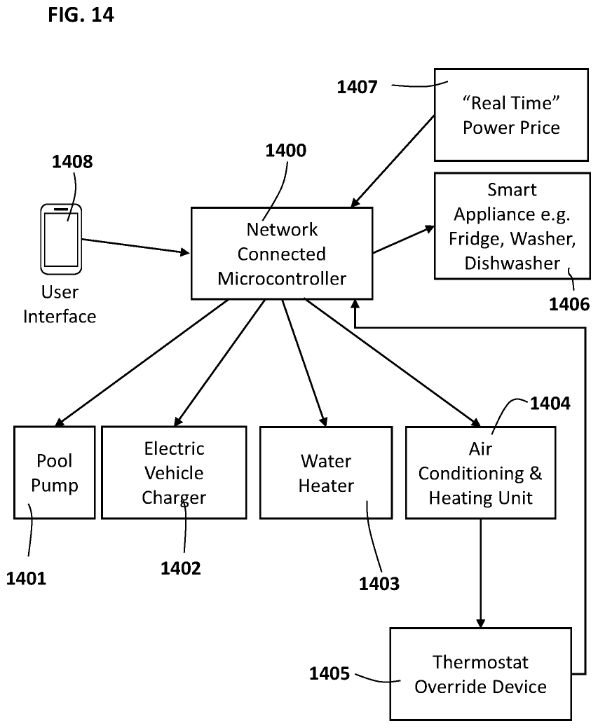

FIG. 14 shows a full overview of all aspects of the present invention. Settings including trigger prices are set in the user interface 1408 by the end user, and the user interface is also used to feed information back to the end user including total and device level power usage as well a real time price information. The network connected microcontroller 1400 receives a real time price 1407 and then uses said real time price combined with the trigger prices for each high power usage device to makes decisions to interrupt or reduce power flow to high power usage devices, 1401, 1402, 1403, 1404, and 1406 where the interruption and reduction will occur through either a hardware switch device, or a software control message. In addition a thermostat override device 1405 connected to an air conditioning system 1404 is used to provide temperature information of the location so further maximum and minimum temperature parameters can be set and used to keep a comfortable temperature for the end user.

1-10. (canceled)

11. A method and user interface for eliciting an end user's preference to cut or reduce power consumption at a high power usage device, comprising; a real time power price, a trigger price, an expected savings, an expected interruption, and an end user interface screen;
wherein said end user is presented through said user interface said expected interruption, and said expected savings; the end user sets said expected interruption and said expected savings to said high power usage device in said user interface; the end user saves the preferred said expected interruption, and said expected savings in said user interface; from the said expected interruption the associated said trigger price is inferred, and used as the trigger price above which to interrupt or reduce electricity usage at said high power usage device; if said real time price is below said trigger price then power is allowed to flow to said high power usage device as it usually would.

12. The invention of claim 11 where the expected savings, expected interruption, and trigger price values are updated instantly by moving a slider in a horizontal motion, where sliding leftwards reduces the trigger price, and sliding rightwards increases the trigger price.

13. The invention of claim 11 whereby the expected interruption and expected savings values are shown graphically for each trigger price level.

14. The invention of claim 13 wherein expected savings and expected interruption are chosen by sliding a vertical line bar horizontally; sliding the vertical line bar leftwards causes the trigger price to reduce and sliding the vertical line bar rightwards causes the trigger price to increase.

15. A method for protecting pool equipment from freezing conditions in a system where said pool equipment is routinely shut down when a real time power price is above a threshold level such as a trigger price;
wherein a process monitors the weather conditions of the pool equipment's location receiving real time temperature data; a cut off temperature level is established near the freezing point of 32° F., below which a signal is sent so that said pool equipment will always have power flow independent of the current real time price.

16. The invention of claim 15 wherein an end user through a user interface inputs the zip code of the pool equipment's location, to use to pull local real time weather information.

17. The invention of claim 15 wherein through a user interface an end user can enable or disable the method described.

18-20. (canceled)
